(19) United States
(12) Patent Application Publication
(10) Pub. No.: US 2010/0330321 A1
(43) Pub. Date: Dec. 30, 2010

(54) COVER LAYER FOR PRINTED CIRCUIT BOARD

(75) Inventors: Chih-Ming Lin, Hsinchu (TW); Shou-Jui Hsiang, Hsinchu (TW); Chien-Hui Lee, Hsinchu (TW)

Correspondence Address: TUROCY & WATSON, LLP, 127 Public Square, 57th Floor, Key Tower, CLEVELAND, OH, 44114, US

(73) Assignee: ASIA ELECTRONIC MATERIAL CO., LTD, Chubei City (TW)

(21) Appl. No.: 12/822,540

(22) Filed: Jun. 24, 2010

(30) Foreign Application Priority Data
Jun. 25, 2009 (TW) 098211427

(51) Int. Cl. G02B 1/11; B32B 27/08; B32B 27/20; B32B 7/02

(52) U.S. Cl. 428/41.8; 428/213; 428/216

(57) ABSTRACT

The present invention provides a cover layer for a printed circuit board. The cover layer includes a first polymer layer, a second polymer layer and a light-reflecting layer disposed between the first and second polymer layers and having a thickness being 0.5 to 10 micro meters. Due to the light-reflecting layer, the cover layer of the present invention has high reflection rate and great flexibility suitable for a flexible printed circuit board.

### BACKGROUND OF THE INVENTION

1. Field of the Invention

The present invention relates to a cover layer for a printed circuit board, and more particularly, to a cover layer having a light-reflecting layer applicable to an LED backlight module.

2. Description of Related Art

Printed circuit boards are essential components in electrical products. Printed circuit boards are in high demand as the increased demand of commercial electrical products. Flexible printed circuit boards are flexible for 3D wiring, so as to be widely used in computers, communication products, commercial electrical products and the like which need to be thin and small.

Generally, flexible printed circuit boards are formed by flexible copper clad laminates (FCCL) and cover layers (CL). A plastic film is used as or a thin insulating ink layer is printed as a cover layer for a printed circuit board. However, the conventional cover layers have no desired reflection property, resulting in that ink cracks or breaks apart and thus fail to have optimal optical property.

Therefore, there is a need to develop a cover layer having high reflection rate and great flexibility.

### SUMMARY OF THE INVENTION

The present invention provides a cover layer for a printed circuit board. The cover layer of the present invention includes a first polymer layer; a light-reflecting layer having a thickness being 0.5 to 10 micro meters, formed on the first polymer layer and including resin and an additive dispersed in the resin, wherein the additive is titanium dioxide powder, boron nitride powder, a white pigment or a combination thereof; and a second polymer layer formed on the light-reflecting later, disposed between and protected by the first polymer layer and the second polymer layer, wherein the thickness of the first polymer layer is more than the thickness of the second polymer layer. The fabrication of the cover layer in the present invention is simple. The light-reflecting layer is white, and thus has high reflection rate in addition to great flexibility. Hence, the cover layer of the present invention is applicable to the processing of printed circuit boards, especially LED backlight modules which require light reflection property.

### BRIEF DESCRIPTION OF THE DRAWINGS

FIG. 1 shows a cover layer according to an embodiment of the present invention; and

FIG. 2 shows a cover layer according to another embodiment of the present invention.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

In the present invention, lightness (alternatively referred as L value) is defined to reflect brightness of a color. In the present invention, high lightness means a color with weak amplitude, i.e. the color of the cover layer being near white. A dark color has low lightness. In addition, the material having high lightness has high reflection rate. On the other hand, the material having low lightness has low reflection rate.

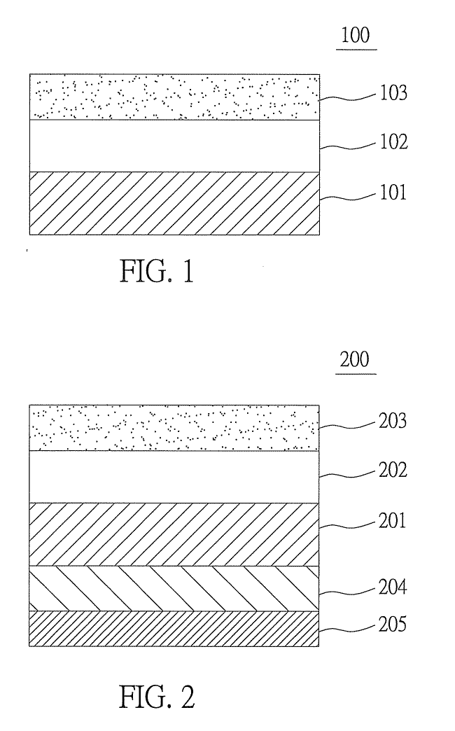

FIG. 1 shows a cover layer 100 of the present invention. The cover layer 100 includes a first polymer layer 101, a light-reflecting layer 102 and a second polymer layer 103. In this embodiment, the cover layer 100 has outstanding light-reflecting property since the light-reflecting layer 102 having a thickness being 0.5 to 10 micro meters is formed on the first polymer layer 101. The light-reflecting layer 102 includes resin and an additive selected from the group consisting of titanium dioxide powder, boron nitride powder, a white pigment and a combination thereof, and thus the cover layer 100 has outstanding reflection rate. In one embodiment, the resin in the light-reflecting layer is epoxy, natural rubber or artificial rubber. The dispersion agent can be added to facilitate the dispersion of the additive, which enhances the light reflection property of the cover layer.

In one embodiment, the additive in the light-reflecting layer is one or more selected from the group consisting of titanium dioxide powder, boron nitride powder, a white pigment and a combination thereof. For example, the additive can be a mixture of titanium dioxide and boron nitride, or a mixture of a white pigment, titanium dioxide and boron nitride. The additive is 60 to 95 wt % of resin. In addition, a color can come from a dye or a color powder, and be made of organic or inorganic material.

It was found that the mixture of the additive and resin resulted in outstanding reflection rate of the cover layer. The light-reflecting layer does not peel off the cover layer even the additive is 95 wt % of the resin as long as the thickness of the light-reflecting layer is controlled to be between 0.5 to 10 micro meters (preferably 5 to 8 micro meters). Further, the cover layer of the present invention include a second polymer layer for protecting the light-reflecting layer, such that the cover layer will not turn into yellow in high moisture and at high temperature. Hence, the lifetime and reliability of the cover layer are enhanced.

Moreover, in order to form a cover layer applicable to a flexible printed circuit board and effectively control the cost, the thickness of the second polymer layer is controlled to be between 3 to 15 micro meters, and the thickness of the first polymer layer is controlled to be between 13 to 25 micro meters, wherein the thickness of the first polymer layer is more than the thickness of the second polymer layer.

In the present invention, the material of the second polymer layer is preferably, but not limited to, thermal curing resin or photocuring resin, and more preferably thermal curing resin. The material of the first polymer layer selected from the group consisting of polyimide, polyethylene terephthalate, polyaniline, polyethylene naphthalate, triacetine and polycarbonate, and preferably polyimide and polyethylene terephthalate. Generally, the material of the second polymer layer can be the same as that of the first polymer layer as long as the thickness of the first polymer layer is more than that of the second polymer layer.

FIG. 2 shows a cover layer 200 according another embodiment of the present invention. The cover layer 200 includes a first polymer layer 201, a light-reflecting layer 202, a second polymer layer 203, an adhesive layer 204 formed on the first polymer layer 201, and a release film 205 attached on an outer surface of the adhesive layer 204, wherein the first polymer layer 201, a light-reflecting layer 202 and the second polymer layer 203 have similar structure as that in FIG. 1. The adhesive layer 204 is used for attaching the wiring layer of the printed circuit board. The attachment of the release film 205 keeps the adhesive layer 204 being adhesive.

### Example I

### Formation of a Cover Layer

A polyimide film having a thickness being 13 micro meters was used as a substrate of a first polymer layer. The polyimide film was coated with liquid having epoxy resin, titanium dioxide and a dispersion agent, and after the liquid was dried and cured, a light-reflecting layer having a thickness being about 5 micro meters was formed. The light-reflecting layer was coated with liquid having thermal curing resin or photocuring resin, after the liquid was cured, a second polymer layer having a thickness being about 10 micro meters was formed, and a cover layer was thus formed.

### Example II

### Formation of a Cover Layer

An adhesive agent was applied on the first polymer layer of the cover layer of Example I, and thus an adhesive layer was formed. A release film was attached on the adhesive layer to keep adhesiveness of the adhesive layer, so as to facilitate subsequent processing.

### Test of Reflection Rate

The cover layer of Example I (sample 1) and a layer (sample 2) coated with ink having epoxy resin but no titanium dioxide were tested by light density measuring instrument. The results are shown in Table 1.

TABLE 1
Reflection rates of cover layers having different inks

| | Total | Light-reflecting layer | | | | |
|---|---|---|---|---|---|---|
| | thick- | Thick- | | | | |
| Sample | ness | ness | | Content | Reflection | Anti- |
| No. | (um) | (um) | additives | (wt %) | rate (%) | scratch |
| 1 | 28 | 5 | Epoxy resin, | 90 | 92 | 3H |
| | | | titanium | | | |
| | | | dioxide | | | |
| 2 | 28 | 5 | | — | 85 | 1H |

As shown in Table 1, the cover layer having the light-reflecting layer which has titanium dioxide of the present invention has higher reflection rate than the cover layer without titanium dioxide. In addition, it is found that in the anti-scratch test, the light-reflecting layer of the present invention has better anti-scratch property than the common ink with 1H anti-scratch.

Further, the cover layer including boron nitride as an additive has better reflection rate and anti-scratch property than the cover layer having the common ink.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A cover layer for a printed circuit board, comprising:
a first polymer layer;
a light-reflecting layer formed on the first polymer layer, having a thickness being 0.5 to 10 micro meters, and comprising resin and an additive dispersed in the resin, wherein the additive is titanium dioxide powder, boron nitride powder, a white pigment or the combination thereof; and
a second polymer layer formed on the light-reflecting layer, wherein the light-reflecting layer is disposed between and protected by the first polymer layer and the second polymer layer,
wherein a thickness of the first polymer layer is more than a thickness of the second polymer layer.

2. The cover layer of claim 1, further comprising an adhesive layer formed on the first polymer layer, and the first polymer layer is disposed between the adhesive layer and the light-reflecting layer.

3. The cover layer of claim 2, further comprising a release film attached on an outer surface of the adhesive layer.

4. The cover layer of claim 1, wherein the thickness of the second polymer layer is ranged between 3 to 15 micro meters.

5. The cover layer of claim 4, wherein the thickness of the first polymer layer is ranged from 13 to 25 micro meters.

6. The cover layer of claim 5, wherein the thickness of the adhesive layer is ranged from 10 to 25 micro meters.

7. The cover layer of claim 6, wherein the second polymer layer is made of thermal curing resin or photocuring resin.

8. The cover layer of claim 6, wherein the first polymer layer is made of polyimide, polyethylene terephthalate, polyaniline, polyethylene naphthalate, triacetine or polycarbonate.
